(19) United States
(12) Patent Application Publication
(10) Pub. No.: US 2013/0107029 A1
(43) Pub. Date: May 2, 2013

(54) SYSTEMS, METHODS, AND APPARATUS FOR MONITORING INFANTS

(71) Applicant: MySnapCam, LLC, Atlanta, GA (US)

(72) Inventors: Donald Lee Knasel, Atlanta, GA (US); William Henry Donges, Dunwoody, GA (US)

(73) Assignee: MySnapCam, LLC, Atlanta, GA (US)

(21) Appl. No.: 13/662,054

(22) Filed: Oct. 26, 2012

Related U.S. Application Data
(60) Provisional application No. 61/551,766, filed on Oct. 26, 2011.

(51) Int. Cl. H04N 7/18

(52) U.S. Cl. 348/77; 348/E07.085

(57) ABSTRACT

Systems, methods, and apparatus for infant monitoring, including video and/or audio monitoring are described. In certain embodiments, a camera may be provided for monitoring an infant. The camera may be configured to communicate with a user device. The camera may be configured to operate in either a local communications sessions, such as peer-to-peer mode over a local network or in a remote mode over a wide area network. While operating in a peer-to-peer mode, a relatively high bandwidth local area connection may be utilized to communicate video and/or audio information to a user device. While operating in a remote or network hosting mode, one or more lower quality signals may be communicated to a user device. For example, a lower resolution video signal may be communicated to a user device and/or a voice over Internet protocol (“VoIP”) audio signal may be communicated to the user device.

### RELATED APPLICATIONS

This application claims priority to U.S. Provisional Patent Application No. 61/551,766, entitled “Systems, Methods, and Apparatus for Monitoring Infants,” filed on Oct. 26, 2011, which is incorporated by reference as if fully set forth herein.

### TECHNICAL FIELD

Embodiments of the invention relate generally to infant monitoring systems, and more specifically to video infant monitoring systems.

### BACKGROUND

A wide variety of conventional monitoring systems, including audio and video monitors, are utilized to monitor infants. Typically, a video monitor includes a camera and a video receiver that receives a video signal from the camera. However, the video resolution of these conventional devices is typically relatively low. Additionally, the communications range between the camera and the video receiver is typically limited. Thus, a video receiver typically cannot receive a video signal when the video receiver is taken outside of a home.

Recently, video cameras have been developed that permit the communication of a video signal over a wide area network, such as the Internet. The video signal can then be received and displayed by an Internet-connected device, such as a mobile device or personal computer. However, network bandwidth may be limited over a wide area network that facilitates Internet communications, thereby limiting the resolution of a video signal. For example, devices that communicate via a cellular network (i.e., mobile devices, etc.) may only be permitted to receive a certain amount of data and/or data rates may be limited. Thus, although an Internet-based camera may be convenient for use when a reception device is located remotely from the camera, the Internet-based camera is often not convenient for use when the reception device is located within a home.

Accordingly, there is an opportunity for improved systems, methods, and apparatus for infant monitoring.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of one example system that may be utilized to facilitate video infant monitoring, according to an illustrative embodiment of the invention.

FIG. 2 is a flow diagram of an example method for outputting monitoring data by a monitoring device, according to an illustrative embodiment of the invention.

FIG. 3 is a flow diagram of an example method for receiving monitoring data by a user device, according to an illustrative embodiment of the invention.

FIG. 4 is a flow diagram of an example method for communicating audio data from a user device to a monitoring device, according to an illustrative embodiment of the invention.

### DETAILED DESCRIPTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are systems, methods, and apparatus for monitoring an infant. Although the embodiments described herein are directed to monitoring an infant, it will be appreciated that the present disclosure should not be limited to those embodiments. The systems, methods, and apparatus may be directed to monitoring other living beings, including but not limited to, people and animals. For example, monitoring may be used in conjunction with infants, elder care patients, and animals.

Disclosed are systems, methods, and apparatus for infant monitoring, including video and/or audio monitoring. In certain embodiments, at least one camera may be provided for monitoring an infant. Additionally, in certain embodiments, the camera may be configured to communicate with one or more user devices (e.g., a mobile device, a tablet computer, a personal computer, a designated receiver device, etc.). Alternatively, in other embodiments, the camera may be associated with a suitable gateway device configured to communicate with the one or more user devices. The camera (or, as desired, the gateway device) may be configured to operate in either a peer-to-peer mode (or another convenient operational mode) over a local network (e.g., a local area network, a Wi-Fi network, a Bluetooth network, etc.) or in a remote mode over a wide area network (e.g., the Internet, a cellular network, etc.). While operating in a peer-to-peer mode, a relatively high bandwidth local area connection may be utilized to communicate video and/or audio information to a user device. For example, a relatively higher resolution or high definition video signal may be communicated to a user device. While operating in a remote or network hosting mode, one or more lower quality signals may be communicated to a user device. For example, a lower resolution video signal may be communicated to a user device and/or a voice over Internet protocol (“VoIP”) audio signal may be communicated to the user device.

As desired, the camera (or gateway device) may additionally be configured to communicate a wide variety of alert messages to a user device. For example, an associated microphone may be configured to capture audio associated with an infant and at least a portion of the collected audio may be compared to predetermined values and/or threshold values, such as amplitude threshold values and/or predetermined baseline values associated with an expected infant heartbeat and/or breathing. In the event that a threshold is not satisfied by collected audio, an alert message may be communicated to a user device. As desired, a monitoring application resident on the user device may additionally be woken up and/or activated. A wide variety of other operations may be performed by the camera as desired in various embodiments. For example, the camera may be configured to receive audio data (e.g., music, voice data, etc.) from the user device, and the camera may include a suitable speaker configured to output at least a portion of the received audio data.

Additionally, a wide variety of different types of user devices may be utilized in conjunction with various embodiments of the invention, such as mobile devices, tablet computers, personal computers, audio devices, etc. In certain embodiments, a user device may be configured to execute one or more suitable monitoring applications that facilitate communication and/or interaction with the camera (or gateway device). For example, a dual-mode application may be executed. The dual-mode application may facilitate connection via either a local network or a remote network (e.g., a wide area network, etc.). For example, if the user device is situated within a household, then a local network connection may be established. As another example, if the user device is situated outside of the household or outside of the range of a local network, then a remote connection may be established. The data received by the user device (e.g., video data, audio data, VoIP data, etc.) may be based at least in part upon the type of connection that is established.

As desired, the user device and/or the monitoring application may additionally be configured to receive and/or process alert and/or wake-up messages. In the event that the monitoring application is operating in a low power or sleep mode, a received message may facilitate a wake-up operation and/or the output of an alert (e.g., an audio alert, a vibration alert, etc.) by the user device. A wide variety of user input may then be received, and the user input may be processed in order to activate the monitoring application and/or facilitate the output of video and/or audio data. For example, a user may shake a user device, and an accelerometer associated with the user device may register the motion. The monitoring application may then process the motion data and activate the output of video and/or audio data. In this regard, if an alert is received in the middle of the night, a user may easily establish the output of a video/audio feed by the user device.

In certain embodiments, a user device may additionally be configured to operate in conjunction with a suitable docking station. For example, a mobile device, audio device (e.g., music device, etc.), or tablet computer may be configured to operate in conjunction with a docking station, such as a docking station that includes one or more speakers. While connected to the docking station, the monitoring application may identify the docking station and/or determine audio capabilities associated with the docking station. The monitoring application may then optimize audio data that is output by the user device. For example, an audio signal may be optimized and output via a data bus associated with the docking device. Additionally, the user device may be configured to communicate audio data (e.g., stored music and/or other audio data, received voice data, audio data retrieved from one or more cloud storage devices, etc.) to the camera (or gateway device) for output to the infant. For example, lullabies and/or other music may be communicated to the camera for output.

Structural Overview

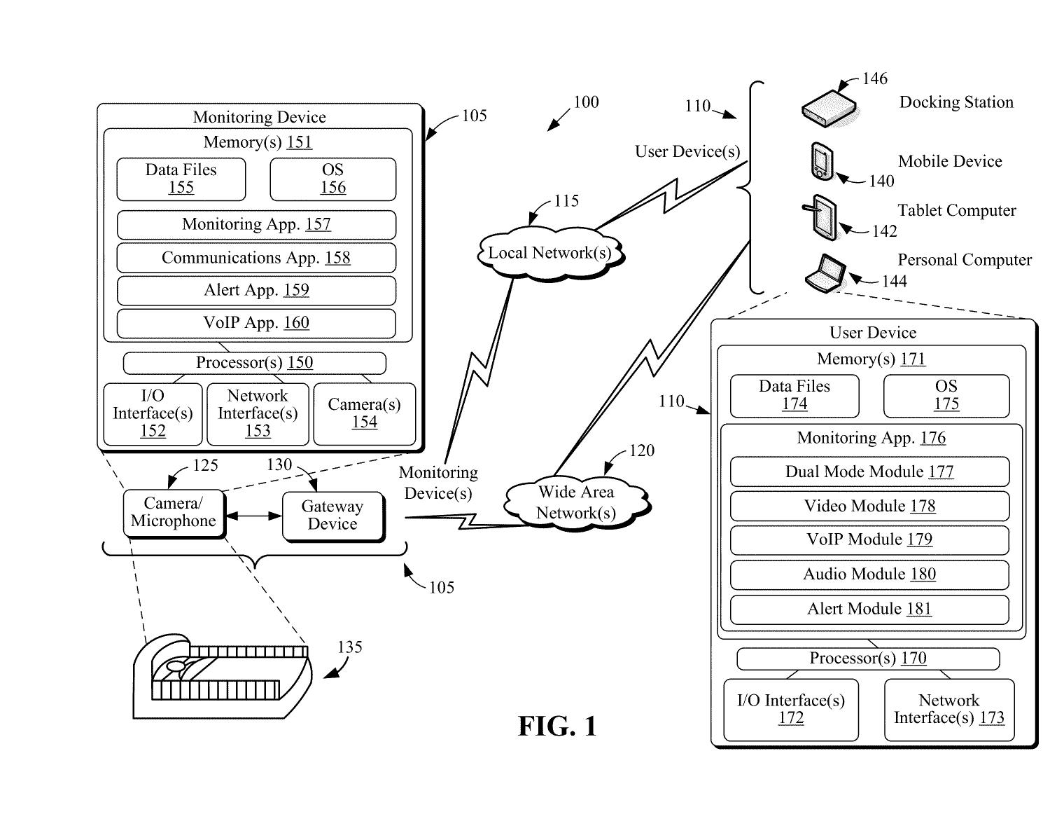

FIG. 1 illustrates one example system 100 that may be utilized to facilitate video infant monitoring. With reference to FIG. 1, the system 100 may include one or more monitoring devices 105 and one or more user devices 110. Any number of suitable networks, such as one or more local networks 115 and/or one or more wide area networks 120, may facilitate communication between the monitoring devices 105 and the user devices 110. The monitoring devices 105 may include a suitable camera device 125 (referred to herein as camera 125) configured to provide video and, as desired, audio monitoring of an infant 135. In certain embodiments, the camera 125 may be configured to host one or more network communications sessions with the user devices 110. In other embodiments, a suitable gateway device 130, such as a router or other gateway device, may be in communication with the camera 125, and the gateway device 130 may be configured to host one or more network communications sessions with the user devices 110.

Additionally, the user devices 110 may include a wide variety of different types of devices, such as a mobile device 140 (e.g., a mobile phone, etc.), a tablet computer 142, a personal computer 144, or an audio device (e.g., a digital audio player, etc.). As desired, a suitable docking station 146 may be provided, and the docking station 146 may operate in conjunction with another user device, such as a mobile device 140. In operation, a user device 110 may be configured to communicate with at least one monitoring device 105 to facilitate the receipt of infant monitoring data, such as video and/or audio data. Each of the components of the system 100 will now be described in greater detail.

With reference to FIG. 1, a monitoring device 105 may be a suitable processor-driven device that facilitates the monitoring of an infant and/or communication with a user device 110. For example, the monitoring device 105 may include a camera 125 with processing and/or network hosting capabilities or a camera 125 in communication with a suitable gateway device 130. As desired, the monitoring device 105 may include any number of microcontrollers, minicomputers, and/or other suitable processor-driven devices. One or more processors 150 associated with the monitoring device 105 may be configured to execute computer-readable instructions in order to form a special-purpose computer or particular machine that is configured to monitor an infant and provide monitoring data and/or other data to a user device 110. Although an example monitoring device 105 is described as a single device, the described components may be distributed among any number of suitable devices.

In addition to having one or more processors 150, the monitoring device 105 may include one or more memory devices 151, one or more input/output (“I/O”) interfaces 152, one or more network interfaces 153, and/or one or more cameras 154 and/or other sensors. The memory devices 151 may include any suitable memory devices and/or data storage elements, such as read-only memory devices, random access memory devices, magnetic storage devices, flash memory devices, etc. The memory devices 151 may be configured to store a wide variety of information, for example, data files 155, and/or any number of software modules and/or executable instructions that may be executed by the one or more processors 150, such as an operating system (“OS”) 156, a monitoring application 157, a communications application 158, an alert application 159, and/or a VoIP application 160.

The data files 155 may include any suitable data that facilitates the operation of the monitoring device 105, such as data that facilitates identification of the one or more cameras 154 or other sensors (e.g., a microphone, etc.), data that facilitates communication with the sensors, data that facilitates the identification of input and/or output devices (e.g., one or more speakers, etc.), data that facilitates communication with one or more user devices 110 and/or gateway devices, baseline and/or threshold audio data (e.g., baseline audio data associated with an expected infant breathing or heartbeat signature, threshold audio level data, etc.), data associated with the generation of alerts, and/or collected monitoring data (e.g., video data, audio data, etc.).

The OS 156 may be a suitable software module that facilitates the general operation of the monitoring device 105. Additionally, the OS 156 may facilitate the execution of any number of other software modules, such as the monitoring application 157, the communications application 158, the alert application 159, and/or the VoIP application 160. The monitoring application 157 may include any number of suitable software modules and/or applications configured to collect and/or process information associated with a monitored infant 135. In operation, the monitoring application 157 may collect video data associated with the monitored infant 135 from the cameras 154. The monitoring application 157 may additionally collect audio data from any number of suitable microphones or other audio collection devices. As desired, the monitoring application 157 may process the received data in order to format the data for communication to a user device 110. For example, the monitoring application 157 may process received data in order to provide a desired resolution level for the data. Alternatively, the monitoring application 157 may utilize information associated with a desired resolution level in order to configure the cameras 154 and/or other data collection devices.

The communications application 158 may include any number of suitable software modules and/or applications that facilitate communication with one or more user devices 110. In operation, the communications application 158 may be configured to operate in a plurality of different modes, such as a local communications mode and a remote or network-hosted communications mode. In certain embodiments, a peer-to-peer communications session may be established between the monitoring device 105 and a user device 110 when operating in a local communications mode. Additionally, in certain embodiments, the monitoring device 105 may function as a local area network access point, such as a Wi-Fi access point that facilitates communication with the user devices 110. In embodiments in which the monitoring device 105 acts as an access point, easier set-up and/or establishment of a communications network may be facilitated. For example, a user who implements the monitoring device 105 will not be required to set up and/or configure the monitoring device 105 with a local network.

In either operating mode, the communications application 158 may be configured to establish communication with a user device 110 and communicate monitoring data and/or messages to the user device 110. However, a type of operating mode may facilitate the determination and/or resolution of data that is communicated to the user device 110. For example, if operating in a local communications mode (e.g., a communications session established via a local network 115), relatively higher resolution data may be communicated to a user device 110. In certain embodiments, high definition video data may be communicated. In this regard, relatively higher available bandwidth associated with the local network 115 may be utilized. As another example, if operating in a remote communications mode (e.g., a communications session established via a wide area network 120), lower resolution video data may be communicated. In certain embodiments, network resources and/or other factors associated with an established communications session (e.g., available bandwidth, data transmission costs, etc.) may be evaluated in order to optimize the resolution of a video feed.

Additionally, a type of operating mode may be utilized to facilitate a type of audio data that is communicated. For example, if operating in a remote communications mode, VoIP technology may be utilized to facilitate the communication of audio data. In this regard, the bandwidth utilized to transmit audio data may be minimized and/or optimized. As desired, VoIP technology may additionally or alternatively be utilized when operating in a local communications mode.

In certain embodiments, the communications application 158 may be configured to determine a type of communications session that should be established with a user device 110. A wide variety of suitable methods and/or techniques may be utilized to determine a type of communications session (i.e., local or remote). For example, an Internet Protocol address of a user device 110 may be evaluated in order to determine whether the user device 110 is connecting locally (e.g., connecting directly with the monitoring device 105, connecting via a local router or gateway device, etc.). As another example, if it is determined that the user device 110 is connected via a cellular network, then a remote network communication may be identified. As another example, a network hop count and/or latency may be evaluated in order to determine whether the user device 110 is connecting locally or remotely. In another example, the communications application 158 may receive information associated with other devices in communication with the user device 110 (e.g., a mesh fingerprint, etc.). The received information may be compared to information associated with known local devices in order to determine whether the user device 110 is connected locally.

Additionally, in certain embodiments, the communications application 158 may be configured to receive a wide variety of information from a user device 110. For example, the communications application 158 may be configured to receive user commands from a user device 110, such as a command to activate video monitoring, a command to activate audio monitoring, and/or a recording command (i.e., a command that facilitates local recording within the memory 151). As another example, the communications application 158 may receive data from the user device 110 to be output. For example, audio data (e.g., music data, user voice data, etc.) may be received for output to the infant 135. In this regard, various music and/or other audio, such as music stored by the user device 110 and/or music accessed by the user device 110 from another device (e.g., another user device, a cloud-based server, etc.) may be received and output by the monitoring device 105.

The alert application 159 may include any number of suitable software modules and/or applications that facilitate the identification and/or generation of one or more alert messages associated with the monitored infant 135. In operation, the alert application 159 may compare collected monitoring data, such as collected audio data associated with the infant 135, to threshold data and/or baseline data. In this regard, the alert application 159 may determine whether an alert should be generated. As one example, an amplitude of collected audio may be compared to a threshold value. If the amplitude exceeds the threshold value, a suitable alert may be generated. For example, if an infant 135 begins to cry, and the amplitude of the crying exceeds a threshold value, an alert may be generated.

As another example, audio data associated with the heartbeat and/or breathing of the infant 135 may be collected. For example, one or more special-purpose microphones may be utilized to isolate and capture heartbeat and/or breathing data. In certain embodiments, a phased array of ultrasonic devices and/or sensors may facilitate the amplification and/or isolation of the heartbeat and/or breathing audio. The alert module 159 may compare the collected data to baseline or profile data associated with an infant heartbeat and/or breathing. In this regard, the alert application 159 may determine whether monitored breathing/heartbeat data deviates from expected or baseline data. In the event that a deviation is identified by the alert application 159, the alert application 159 may take and/or direct any number of suitable control actions. For example, the alert application 159 may direct the output of an audible alarm. As another example, the alert application 159 may communicate an alert message to the user device 110. In another example, the alert application 159 may direct the activation of one or more additional sensor devices, such as the camera 154.

A wide variety of suitable methods and/or techniques may be utilized by the alert application 159 to facilitate the communication of an alert message. For example, in-application messages may be communicated to a monitoring application 176 associated with the user device 110. As another example, short message service (“SMS”) messages may be communicated to a user device 110. Additionally, in certain embodiments, an activation and/or wake-up message may be communicated to a user device 110. In this regard, a monitoring application 176 resident on the user device 110 may be activated and/or woken up from a power saving mode.

The VoIP application 160 may include any number of suitable software modules and/or applications that facilitate the generation of voice over Internet protocol (“VoIP”) audio data to be communicated to a user device 110. In operation, the VoIP application 160 may be configured to process audio data collected by the monitoring device 105 in order to generate any number of Internet Protocol packets of information associated with the audio data. In this regard, audio may be communicated to a user device 110 utilizing a suitable VoIP communications standard or protocol. For example, if remote communication is established with a user device 110, VoIP communication may be utilized to communicate an audio feed to the user device 110. In this regard, cellular minutes associated with certain user devices (e.g., mobile devices, etc.) will not be utilized in conjunction with remote communication. In addition to including a VoIP application 160, the monitoring device 105 may also include a wide variety of suitable firmware that facilitates VoIP communication. In certain embodiments, the VoIP application 160 may additionally facilitate the processing of VoIP audio data received from a user device 110.

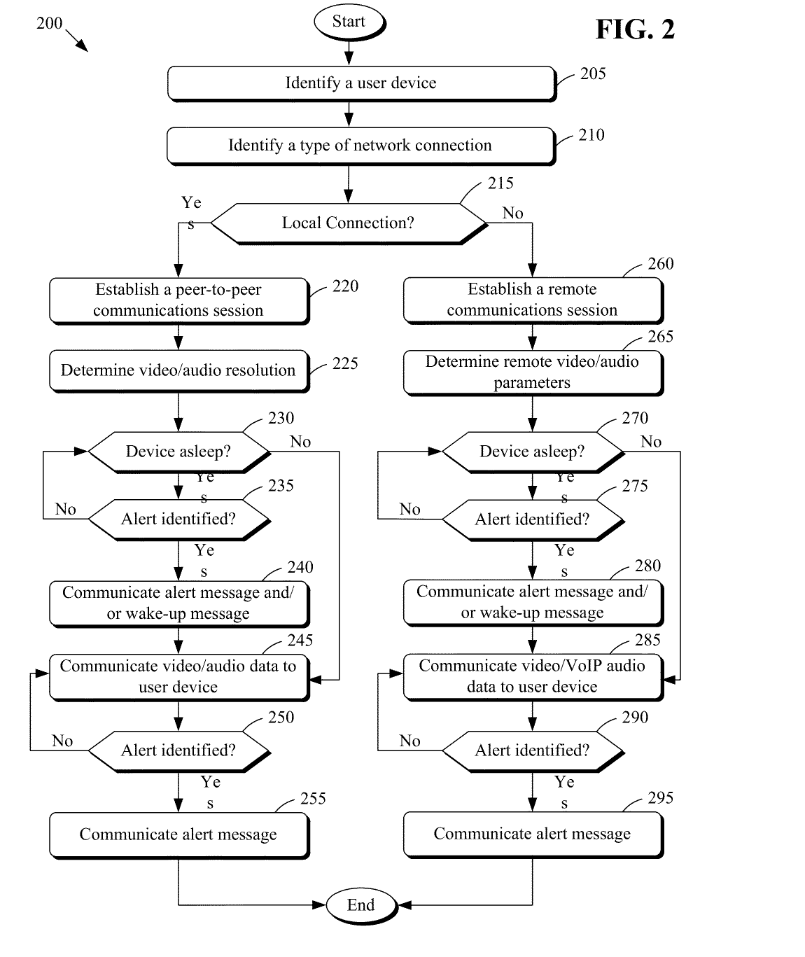

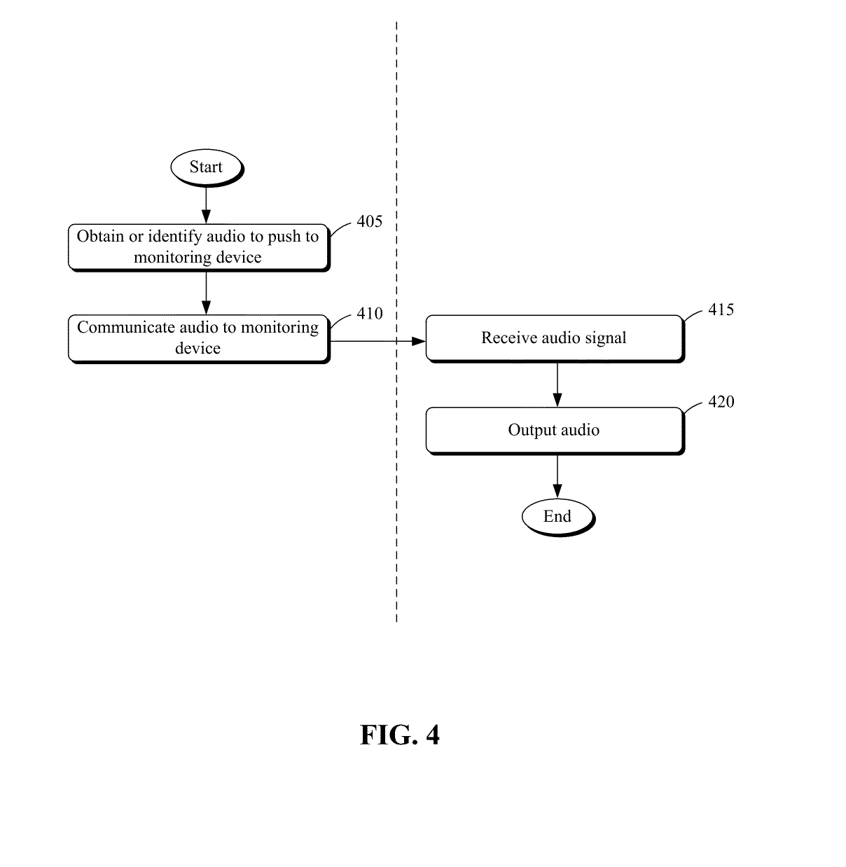

A few examples of the operations that may be performed by the various modules of the monitoring device 105 are described in greater detail below with reference to FIGS. 2 and 4.

With continued reference to the monitoring device 105, any number of suitable cameras 154 and/or other sensors may be provided. For example, one or more cameras 154 may be provided, including standard definition and/or high definition cameras. Additionally, any number of microphones and/or other audio capture devices may be included. In certain embodiments, the monitoring device 105 may also include an array (e.g., a rectangular array, etc.) of sonic and/or ultrasonic sensors, such as sonic and/or ultrasonic microphones, that facilitates the isolation and/or collection of audio associated with an infant heartbeat and/or breathing.

The one or more input/output (“I/O”) interfaces 152 may facilitate interaction with any number of I/O devices that facilitate the receipt of user and/or device input by the monitoring device 105, such as a touch screen display, any number of push buttons, etc. Additionally, the one or more network interfaces 153 may facilitate connection of the monitoring device 105 to any number of suitable networks, such as the local networks 115 and/or wide area networks 120 illustrated in FIG. 1. In this regard, the monitoring device 105 may communicate with any number of other components of the system 100. For example, the monitoring system 105 may communicate with the various user devices 110.

Additionally, as desired in various embodiments, the system 100 may include any number of suitable user devices 110. A wide variety of user devices 110 may be utilized as desired, such as mobile devices 140, tablet computers 142, personal computers 144, and/or audio devices (e.g., music players, etc.). Each user device 110 may be a suitable processor-driven device that may be utilized to communicate with the monitoring device 105. For example, alert messages and/or data feeds may be received from the monitoring device 105. As another example, a user device 110 may be utilized to activate the monitoring device 105. In certain embodiments, a user device 110 may additionally be utilized in conjunction with a suitable docking station 146. In other embodiments, a user device 110 may be connected to another suitable device that facilitates the output of data, such as a television. In certain embodiments, a user device 110 may be pre-configured to work in conjunction with a monitoring device 105. For example, a user device 110 (e.g., a tablet device, etc.) may be packaged and sold in conjunction with a monitoring device 105. In other embodiments, a user may install one or more monitoring applications on a user device 110 in order to utilize the user device 110 in conjunction with a monitoring device 105.

A user device 110 may be a suitable processor-driven device that facilitates communication with a monitoring device 105 in association with infant monitoring. As desired, a user device 110 may include any number of personal computers, microcontrollers, minicomputers, mobile operating devices, and/or other suitable processor-driven devices. One or more processors 170 associated with the user device 110 may be configured to execute computer-readable instructions in order to form a special-purpose computer or particular machine that is configured to receive infant monitoring data and/or facilitate communication with a monitoring device 105.

In addition to having one or more processors 170, the user device 110 may include one or more memory devices 171, one or more input/output (“I/O”) interfaces 172, and/or one or more network interfaces 173. The memory devices 171 may include any suitable memory devices and/or data storage elements, such as read-only memory devices, random access memory devices, magnetic storage devices, flash memory devices, etc. The memory devices 171 may be configured to store a wide variety of information, for example, data files 174, and/or any number of software modules and/or executable instructions that may be executed by the one or more processors 170, such as an operating system (“OS”) 175 and/or one or more monitoring applications 176. In certain embodiments, a monitoring application 176 may be a special-purpose monitoring application installed on, downloaded to, provisioned to (e.g., over the air provisioning, etc.), and/or otherwise provided to the user device 110. Additionally, the monitoring application 176 may include any number of suitable modules, such as a dual mode module 177, a video module 178, a VoIP module 179, an audio module 180, and/or an alert module 181.

The data files 174 may include any suitable data that facilitates the operation of the user device 110, such as data that facilitates communication with the monitoring devices 105, received monitoring data (e.g., video data, audio data, etc.), and/or received alert data. The OS 175 may be a suitable software module that facilitates the general operation of the user device 110. Additionally, the OS 175 may facilitate the execution of any number of other software modules, such as the monitoring applications 176. The monitoring applications 176 may include any number of suitable software modules and/or applications configured to receive and/or process information associated with a monitored infant 135. In certain embodiments, a monitoring application 176 may be a special-purpose application that facilitates communication and/or interaction with the monitoring device 105. Additionally, as set forth above, the monitoring application 176 may include any number of modules and/or may perform a wide variety of different functions. A few example modules of the monitoring application 176 will now be described in greater detail.

In certain embodiments, the monitoring application 176 may include a dual mode module 177. The dual mode module 177 may include any number of suitable software modules that facilitate the establishment of communication with the monitoring device 105. The dual mode module 177 may be configured to operate in a plurality of different modes, such as a local communications mode and a remote or network-hosted communications mode. For example, in the event that direct communication may be established via a local network 115, a local communications mode may be established by the dual mode module 177. In certain embodiments, a peer-to-peer communications session may be established between a monitoring device 105 and the user device 110 when operating in a local communications mode. As another example, in the event that communication is established via a wide area network 120 (e.g., communication is established via a cellular network, the Internet, or another wide area network), a remote communications mode may be established.

As desired, a type of operating mode may facilitate the determination and/or resolution of data that is requested by and/or received by the user device 110. For example, if operating in a local communications mode (e.g., a communications session established via a local network 115), relatively higher resolution data may be received by the user device 110. In certain embodiments, high definition video data may be communicated. In this regard, relatively higher available bandwidth associated with the local network 110 may be utilized. As another example, if operating in a remote communications mode (e.g., a communications session established via a wide area network 120), lower resolution video data may be received. In certain embodiments, network resources and/or other factors associated with an established communications session (e.g., available bandwidth, data transmission costs, etc.) may be evaluated in order to optimize the resolution of a video feed. Additionally, in certain embodiments, the dual mode module 177 may identify a type of operating mode, and the dual mode module 177 may communicate information associated with the identified operating mode to the monitoring device 105. In this regard, the data feed(s) received from the monitoring device 105 may be optimized. As desired, however, a user of the user device 110 may override a type of data feed that will be received. For example, the user may request a higher resolution or lower resolution feed.

Additionally, in certain embodiments, the dual mode module 177 may be configured to switch between a local operating mode and a remote operating mode. For example, in the event that communication via the local network 115 is lost, the dual mode module 177 may switch to a remote operating mode. As another example, if a user device operating in a remote operating mode identifies and establishes communication with the monitoring device 105 via a local network 115, the dual mode module 177 may switch to a local operating mode.

The monitoring application 176 may additionally include a video module 178 configured to receive, process, and/or output video data received from the monitoring device 105. In operation, the video module 178 may be configured to receive video data, such as a video stream, from a monitoring device 105. The video module 178 may process received video data and output the processed video data for presentation or display via one or more suitable output devices associated with the user device 110, such as a display device (e.g., a liquid crystal display, a light emitting diode display, a touch screen display, etc.). As desired in various embodiments of the invention, a wide variety of different types of video data may be received, such as video streams having different resolutions. For example, a lower resolution video stream may be received when a remote connection is established between the user device 110 and the monitoring device 105. As another example, a higher resolution video stream or a high definition video stream may be received when a local connection is established. Additionally, in certain embodiments, the video module 178 may be configured to optimize video resolution for the user device 110 and/or to adjust the video resolution based upon changes in received resolution. As desired, the video module 178 may additionally optimize resolution based on changes associated with the cameras 154, for example, refocusing by the camera 154 and/or camera movements.

In certain embodiments, the monitoring application 176 may communicate, based on received user input, a wide variety of commands to the monitoring device 105. In this regard, various aspects of the camera 154, such as a pan, a tilt, and/or a rotation, may be controlled by the monitoring application 176. As the camera 154 is adjusted, the video module 178 may optimize a received video feed.

The monitoring application 176 may additionally include a VoIP module 179 that facilitates the receipt and processing of VoIP audio data output by the monitoring device 105. In operation, the VoIP module 179 may be configured to receive Internet Protocol packets of information associated with the audio data, and the VoIP module 179 may reconstitute an audio signal or audio stream utilizing the received packets. In this regard, audio may be received by the user device 110 utilizing a suitable VoIP communications standard or protocol. For example, if remote communication is established with a monitoring device 105, VoIP communication may be utilized to receive an audio feed. In this regard, cellular minutes associated with certain user devices (e.g., mobile devices, etc.) will not be utilized in conjunction with remote communication. Additionally, the VoIP module 179 may facilitate the communication of VoIP audio data to a monitoring device 105. In addition to including a VoIP module 179, the user device 110 may also include a wide variety of suitable firmware that facilitates VoIP communication.

With continued reference to the monitoring application 176, at least one audio module 180 may be included. In operation, the audio module 180 may be configured to process audio data for output by the user device 110 and/or one or more other devices, such as a docking station 146. For example, the audio module 180 may be configured to process received audio streams and/or audio data reconstituted from VoIP data, and the audio module 180 may be configured to output the processed audio data. In certain embodiments, the audio module 180 may output audio data to one or more speakers and/or other output devices associated with the user device 110. In other embodiments, the audio module 180 may output audio data to a suitable data bus or other interface associated with a docking station 146 or docking device. In either case, the audio module 180 may be configured to optimize the output audio data. For example, the audio module 180 may optimize audio to be output by a docking station 146. In certain embodiments, audio data may be optimized separately from video data in order to enhance an overall user experience.

Additionally, in certain embodiments, the audio module 180 may additionally be configured to obtain and communicate audio data to the monitoring device 105 for output. For example, audio data (e.g., music data, etc.) may be accessed from memory or obtained from another device, such as another user device or a cloud-based server, and the audio data may be communicated to the monitoring device 105. As another example, audio data may be collected from a user (e.g., voice collected by a microphone, etc.), and the collected audio data may be communicated to the monitoring device 105. In this regard, various music and/or other audio may be received and output by the monitoring device 105.

The monitoring application 176 may additionally include an alert module 181 configured to receive and process one or more alert messages, wake-up messages, and/or activation messages received from a monitoring device 105. In operation, the alert module 181 may receive an alert message and direct the output of a suitable alert (e.g., an audible alert, a visual alert, a vibration alert, etc.) in order to notify or inform a user of an alert condition. A wide variety of suitable methods and/or techniques may be utilized to receive an alert message, such as in-application messaging, SMS messaging, and/or other messaging techniques.

Additionally, in certain embodiments, the monitoring application 176 may operate in a background mode or a sleep mode. Based upon the receipt of an alert message, the alert module 181 may wake up the monitoring application 176 and/or bring the monitoring application 176 (and an associated video/audio feed) to the front or foreground of the user device 110. Alternatively, certain functionality of the monitoring application 176 may be turned off while the alert module 181 is operating in a background mode. Based upon the receipt of an alert message, the monitoring application 176 may be activated by the alert module 181. In addition to or as an alternative to processing alert messages, in certain embodiments, the alert module 181 may monitor a received audio feed and compare the audio feed to one or more threshold values and/or baseline data. In this regard, the alert module 181 may determine whether an alert should be output by the user device 110.

In certain embodiments, once an alert has been output, a wide variety of suitable input may be received and processed in order to activate the monitoring application 176 and output video and/or audio data. For example, various user key inputs, button presses, and/or interactive touch screen selections may be processed in order to activate the monitoring application 176. As another example, motion associated with the user device 110 (e.g., accelerometers detections, etc.) may be processed in order to activate the monitoring application 176. In this regard, a user may quickly activate the monitoring application 176 in order to view and/or hear the infant 135.

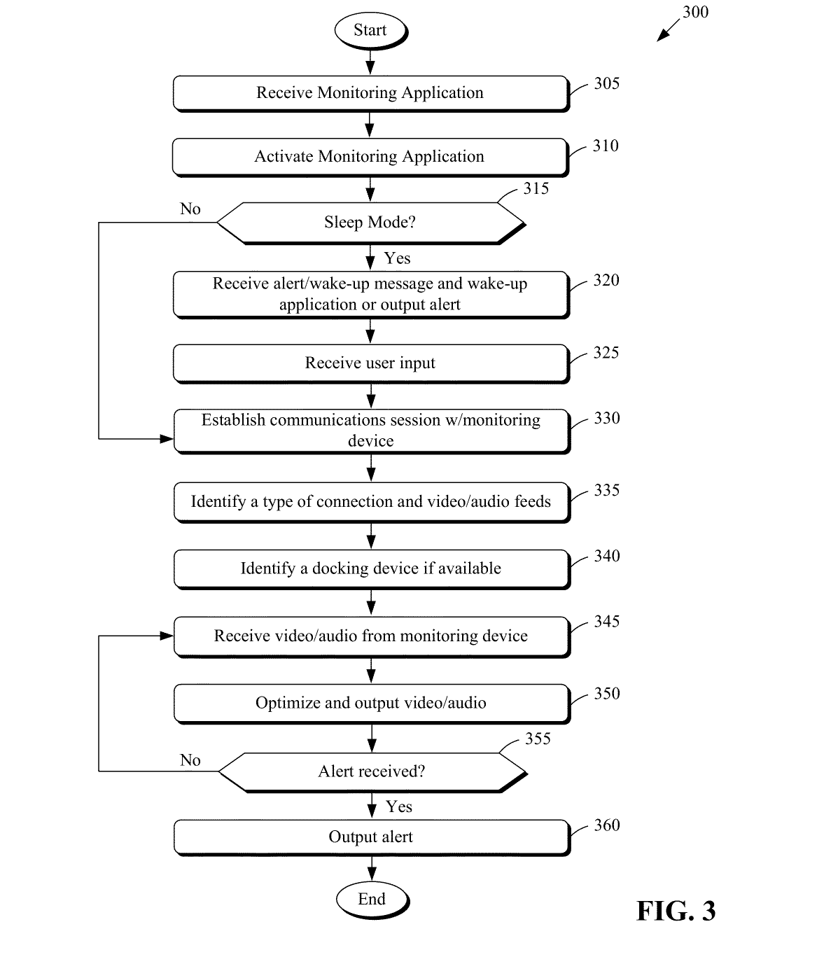

A few examples of the operations that may be performed by the various modules of the user device 110 are described in greater detail below with reference to FIGS. 3 and 4.

The one or more input/output (“I/O”) interfaces 172 may facilitate interaction with any number of I/O devices that facilitate the receipt of user and/or device input by the user device 110, such as a touch screen display, any number of push buttons, a keyboard, a mouse, a microphone, etc. Additionally, the one or more network interfaces 173 may facilitate connection of the user device 110 to any number of suitable networks, such as the local networks 115 and/or wide area networks 120 illustrated in FIG. 1. In this regard, the user device 110 may communicate with any number of other components of the system 100. For example, the user device 110 may communicate with one or more monitoring devices 105.

With continued reference to FIG. 1, any number of suitable networks may facilitate communication between the monitoring devices 105 and the user devices 110. These networks may include any number of local networks 115 and/or any number of wide area networks 120 or remote networks. The local networks 115 may include any number of suitable local area networks, such as a Wi-Fi network, a Bluetooth network, a wireless network, and/or other local networks. In certain embodiments, the local networks 115 may be associated with a relatively higher bandwidth, less delay, and/or lower communication costs than the wide area networks 120. In this regard, the communication of higher resolution data streams may be facilitated via the local networks 115. The wide area networks 120 may include any suitable networks and/or combination of networks that facilitate communications between various remote devices. Examples of suitable wide area networks 120 include, but are not limited to, the Internet, cellular networks, telecommunications networks, and/or other networks.

The system 100 described with reference to FIG. 1 is provided by way of example only. It will be appreciated that other suitable systems and/or devices may be utilized as desired in various embodiments of the invention. These systems and/or devices may include more or less than the components illustrated in FIG. 1.

Additionally, while certain embodiments of the invention are described as being applicable to infant monitoring, other embodiments may be applicable to other types of monitoring, such as the monitoring of pets and/or other animals (e.g., horses in a stall, etc.), the monitoring of elderly persons in eldercare scenarios, and/or to various security monitoring applications.

FIG. 2 is a flow diagram of an example method 200 for outputting monitoring data by a monitoring device, according to an illustrative embodiment of the invention. Various operations of the method 200 may be performed by a suitable monitoring device, such as the monitoring device 105 illustrated in FIG. 1. The method 200 may begin at block 205.

At block 205, a user device, such as the user device 110 illustrated in FIG. 1, may be identified by the monitoring device 105. For example, a user device 110 seeking to establish communications with the monitoring device 105 may be identified. As desired, the user device 110 and/or a user of the user device 110 may be authenticated by the monitoring device 105. For example, a wide variety of login information, digital certificates, and/or other authentication data may be evaluated in order to authenticate the user device 110 and/or a user.

At block 210, a type of network connection between the user device 110 and the monitoring device 105 may be identified or determined. According to an aspect of the invention, a user device 110 may connect to the monitoring device 105 either locally or remotely. As desired, a wide variety of suitable methods and/or techniques may be utilized by the monitoring device 105 to determine a type of connection. For example, an IP address of the user device 110 may be evaluated. As another example, a determination may be made as to whether the user device 110 is connecting via a cellular network or other known wide area network. As another example, a mesh fingerprint of the user device 110 (e.g., information associated with other devices in communication with the user device 110) may be evaluated and compared to a known local device. In another example, a network latency and/or hop count may be evaluated.

At block 215, a determination may be made as to whether the user device 110 is connected locally. If it is determined at block 215 that the user device 110 is not connected locally, then a determination may be made that the user device 110 is connected remotely. Operations may then continue at block 260 described in greater detail below. If, however, it is determined at block 215 that the user device 110 is connected (or connecting) locally, then operations may continue at block 220. At block 220, a peer-to-peer communications session may be established with the user device 110. The peer-to-peer communications session may facilitate the communication of higher resolution audio and/or video data to the user device 110.

At block 225, one or more resolutions for communicating video and/or audio data to the user device 110 may be determined. For example, capabilities and/or available resources of a local connection may be evaluated in order to determine resolutions. As another example, user preferences may be evaluated in order to determine resolutions. In certain embodiments, video and/or audio may be optimized for communication to the user device 110.

At block 230, a determination may be made as to whether the user device 110 is asleep or operating in a standby mode. If it is determined at block 230 that the user device is not asleep, then operations may continue at block 245 described in greater below. If, however, it is determined at block 230 that the user device is asleep, then operations may continue at block 235. At block 235, a determination may be made as to whether an alert has been identified by the monitoring device 105. A wide variety of suitable alerts may be identified as desired in various embodiments of the invention. For example, collected audio data may be compared to a threshold value in order to determine whether an amplitude of the audio data exceeds the threshold value. As another example, collected audio data relating to infant heartbeat and/or breathing may be compared to suitable baseline data, and an alert may be identified based upon a detected deviation. As yet another example, a determination may be made as to whether an alert should be triggered based upon data received from an associated motion sensor or motion pad. If it is determined at block 235 that an alert has not been identified, then operations may continue at block 230, and the user device 110 will not be woken up until either an alert is identified or a user manually wakes up the device 110. If, however, it is determined at block 235 that an alert has been identified, then operations may continue at block 240. At block 240, a suitable alert message and/or wake-up message may be communicated to the user device 110.

At block 245, which may be reached from either block 230 or block 240, video and, as desired, audio data may be communicated to the user device 110 for presentation and/or other output to a user of the user device 110. For example, a video stream and/or an audio stream may be communicated. In certain embodiments, a combined video and audio stream may be communicated. In other embodiments, separate video and audio streams may be communicated. In this regard, the video and audio streams may be separately optimized by the monitoring device 105 and/or the user device 110.

At block 250, a determination may be made as to whether an alert has been identified by the monitoring device 105. If it is determined at block 250 that an alert has not been identified, then operations may continue at block 245, and the monitoring device 105 may continue to communicate video and/or audio data to the user device 110. If, however, it is determined at block 250 that an alert has been identified, then operations may continue at block 255. At block 255, a suitable alert message may be communicated to the user device 110. Operations may then end following block 255.

At block 260, which may be reached from block 215, a remote communications session or a wide area communications session may be established between the monitoring device 105 and the user device 110. The remote communications session may be established via a wide variety of different networks, such as a cellular network, the Internet, etc. At block 265, one or more resolutions and/or parameters for communicating video and/or audio data to the user device 110 may be determined. For example, capabilities and/or available resources of a wide area connection may be evaluated in order to determine resolutions. As another example, user preferences may be evaluated in order to determine resolutions. In certain embodiments, due to lower bandwidth and/or communications cost, relatively lower resolution video and/or audio signals may be communicated. Additionally, in certain embodiments, VoIP technology may be utilized to communicate an audio signal.

At block 270, a determination may be made as to whether the user device 110 is asleep or operating in a standby mode. If it is determined at block 270 that the user device is not asleep, then operations may continue at block 285 described in greater detail below. If, however, it is determined at block 270 that the user device is asleep, then operations may continue at block 275. At block 275, a determination may be made as to whether an alert has been identified by the monitoring device 105. A wide variety of suitable alerts may be identified as desired in various embodiments of the invention, such as the alerts described above with reference to block 235. If it is determined at block 275 that an alert has not been identified, then operations may continue at block 270, and the user device 110 will not be woken up until either an alert is identified or a user manually wakes up the device 110. If, however, it is determined at block 275 that an alert has been identified, then operations may continue at block 280. At block 280, a suitable alert message and/or wake-up message may be communicated to the user device 110.

At block 285, which may be reached from either block 270 or block 280, video and, as desired, audio data may be communicated to the user device 110 for presentation and/or other output to a user of the user device 110. For example, a video stream and/or an audio stream may be communicated. In certain embodiments, a combined video and audio stream may be communicated. In other embodiments, separate video and audio streams may be communicated, such as a VoIP audio stream and a separate video stream. In this regard, the video and audio streams may be separately optimized by the monitoring device 105 and/or the user device 110.

At block 290, a determination may be made as to whether an alert has been identified by the monitoring device 105. If it is determined at block 290 that an alert has not been identified, then operations may continue at block 285, and the monitoring device 105 may continue to communicate video and/or audio data to the user device 110. If, however, it is determined at block 290 that an alert has been identified, then operations may continue at block 295. At block 295, a suitable alert message may be communicated to the user device 110. Operations may then end following block 295.

The method 200 may end following either block 255 or block 295. Alternatively, the method 200 may continually monitor an infant until a monitoring device 105 is switched off or placed in a sleep mode. Additionally, it will be appreciated that a connection between a monitoring device 105 and a user device 110 may switch between a local connection and a remote connection based upon available networks and/or user input.

FIG. 3 is a flow diagram of an example method 300 for receiving monitoring data by a user device, according to an illustrative embodiment of the invention. Various operations of the method 300 may be performed by a suitable user device, such as the user device 110 illustrated in FIG. 1. The method 300 may begin at block 305.

At block 305, a monitoring application (or plurality of applications), such as the monitoring application 176 illustrated in FIG. 1, may be received by the user device 110. A wide variety of suitable methods and/or techniques may facilitate the receipt of the monitoring application 176. For example, the monitoring application 176 may be preloaded or preinstalled on a user device 110, such as a user device distributed in association with a monitoring device 105. As another example, the monitoring application 176 may be downloaded to a user device 110 from a suitable Web server or application server. As yet another example, an over the air provisioning technique may facilitate communication of the monitoring application 176 to the user device 110.

At block 310, the monitoring application 176 may be activated on the user device 110. Once activated, the monitoring application 176 may either be executed as a primary application or at least one component of the monitoring application 176 may be operated as a background application. For example, if no user input is received for a certain period of time, the monitoring application 176 may be placed in a sleep mode or power conservation mode. At block 315, a determination may be made as to whether the monitoring application 176 is operating in a sleep mode. If it is determined at block 315 that the monitoring application 176 is not operating in a sleep mode, then operations may continue at block 330 described in greater detail below. If, however, it is determined at block 315 that the monitoring application 176 is operating or executing in a sleep mode, then operations may continue at block 320. At block 320, an alert and/or wake-up message may be received by the monitoring application 176. For example, an alert module operating as a background thread may receive and process an alert message output by the monitoring device 105. In certain embodiments, once an alert message has been received, a suitable alert indication (e.g., an audio alert, a vibration alert, etc.) may be output by the monitoring application 176. In this regard, a user may be notified of an alert condition.

At block 325, a wide variety of suitable user input may be received and processed in order to wake up the monitoring application 176. In certain embodiments, user input may be received in response to an output alert indication. As one example of user input, a user may utilize various input functionality of the user device 110 (e.g., key presses, touch screen selections, mouse clicks, etc.) to activate or wake up the monitoring application 176. As another example, a user may shake the user device 110, and the motion of the user device 110 may be detected by an accelerometer. The monitoring application 176 may then be woken up based upon collected accelerometer data. Other user input may be processed as desired to wake up a user device 110.

At block 330, which may be reached from either block 315 or block 325, a communications session may be established between the user device 110 and the monitoring device 105. In certain embodiments, the monitoring application 176 may be a dual-mode application configured to establish and, as desired, switch between, a local communications session and/or a remote communications session. At block 335, a type of established connection may be identified. Additionally, the types of one or more video and/or audio feeds that are being received (e.g., high definition video, higher resolution video, lower resolution video, higher resolution audio, lower resolution audio, VoIP audio, etc.) may be identified. Additionally, at block 340, a determination may be made as to whether a docking device, such as the docking station 146 illustrated in FIG. 1, is connected to the user device 110. In the event that a docking station 146 is connected, various parameters and/or capabilities of the docking station 146 may be identified.

At block 345, one or more video and/or audio feeds may be received from the monitoring device 105. At least a portion of the data included in the feeds may be processed for output. The video and/or audio feeds may then be optimized at block 350 and output by the user device 110. For example, the feeds may be optimized based upon the capabilities of the user device 110 and/or an available docking station 146. In certain embodiments, a separate audio output channel may be utilized to drive audio data to a docking station 146. In other embodiments, the monitoring application 176 may be capable of configuring the data provided to a docking station 146. For example, a user may establish various preferences associated with providing data to a docking station 146. As a few examples, a user may adjust volume levels and/or establish conditions associated with driving data to a docking station (i.e., output audio based upon an alert, output audio having an amplitude that exceeds a threshold, etc.). In this regard, an optimal user experience may be provided.

At block 355, a determination may be made as to whether an alert message has been received. If it is determined at block 355 that an alert message has not been received, then operations may continue at block 345, and the user device 110 may continue to receive and process video and/or audio data. If, however, it is determined at block 355 that an alert message has been received, then operations may continue at block 360. At block 360, a suitable alert indication may be output by the user device 110 in a similar manner as that described above with reference to block 320. Operations may then end following block 360.

The method 300 may end following block 360. Alternatively, the method 300 may continue until a monitoring application 176 is exited by a user.

FIG. 4 is a flow diagram of an example method 400 for communicating audio data from a user device to a monitoring device, according to an illustrative embodiment of the invention. Various operations of the method 400 may be performed by a suitable user device and monitoring device, such as the user device 110 and the monitoring device 105 illustrated in FIG. 1. The method 400 may begin at block 405.

At block 405, a user device 110 may obtain or identify audio to be pushed or communicated to the monitoring device 105. For example, audio (e.g., voice data, etc.) may be received by a microphone associated with the user device 110. As another example, music (e.g., lullabies, etc.) and/or other audio data may be accessed from a memory associated with the user device 110. In another example, music and/or other audio data may be obtained by the user device 110 from one or more other devices, such as another user device or a cloud-based server. At block 410, the audio data may be communicated to the monitoring device 105 by the user device 110.

At block 415, the monitoring device 105 may receive the audio data output by the user device 110. The monitoring device 105 may then process the received audio data and output at least a portion of the received audio data at block 420. In this regard, voice data, music, and/or other audio may be received by the monitoring device 105 and output for receipt by a monitored infant.

The method 400 may end following block 420.

The operations described above with respect to the methods 200, 300, 400 illustrated in FIGS. 2-4 are provided by way of example only. As desired, other suitable operations and/or combinations of operations may be utilized in various embodiments of the invention. For example, more or less than the operations illustrated in FIGS. 2-4 may be performed. Additionally, the operations may be performed in any suitable order.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A monitoring system comprising:
at least one sensor configured to collect monitoring data associated with an infant;
at least one communications interface configured to establish a communications session with a user device; and
at least one processor configured to:
identify a type of communications session established with the user device;
generate, at least one data stream for communication to the user device, based upon, at least in part, the type of communications session, the at least one data stream comprising at least a portion of the collected monitoring data; and
direct the communication of the generated at least one data stream to the user device.

2. The monitoring system of claim 1, wherein the at least one sensor further comprises at least one of a camera, a motion detector, or a microphone.

3. The monitoring system of claim 1, wherein the user device further comprises at least one of a mobile device, a tablet computer, an audio device, or a personal computer.

4. The monitoring system of claim 1, wherein the at least one communications interface is further configured to receive audio data from the user device; and
wherein the at least one processor is further configured to direct the output of at least a portion of the received audio data.

5. The monitoring system of claim 1, wherein the at least one processor is further configured to authenticate the user device based upon, at least in part, at least one of login information or a digital certificate.

6. The monitoring system of claim 1, wherein the at least one processor is further configured to identify the type of communication session established with the user device based upon, at least in part, at least one of an IP address of the user device, identification of a cellular network used to communicate with the user device, a mesh fingerprint of the user device, or an evaluation of a network latency associated the user device.

7. The monitoring system of claim 1, wherein the at least one processor is further configured to:
identify a change in a type of network connection established with the user device;
determine a current type of network connection available to connect with the user device; and
establish a new communications session with the user device based upon, at least in part, the current type of network connection.

8. The monitoring system of claim 1, wherein the at least one processor if further configured to:
identify a docking station associated with the user device;
receive one or more parameters of the docking station;
transmit monitoring data based upon, at least in part, the received parameters of the docking station.

9. A computer program product residing on a computer readable medium having a plurality of instructions stored thereon which, when executed by a processor, cause the processor to perform operations comprising:
establishing a communications session with a monitoring device, the communications session comprising one of a local communications session or a remote communications session;
receiving, via the established communications session, at least one data stream comprising monitoring data, wherein a resolution of at least one data stream is based at least in part upon a type of established communications session; and
directing output of the at least one data stream.

10. The computer program product of claim 9, further comprising:
identifying a change in a type of network connection used to establish the communication session with the monitoring device;
determining a current type of network connection available to connect with the monitoring device; and
establishing a new communications session with the user device based upon, at least in part, the current type of network connection, wherein the communications session is one of a location communications session or a remote communications session.

11. The computer program product of claim 9, wherein if the type of established communications session is the local communications session, the resolution of the at least one data stream is high; and
wherein if the type of established communications session is the remote communications session, the resolution of the at least one data stream is low.

12. The computer program product of claim 9, further comprising:
establishing a connection with a docking station; and
transmitting one or more parameters associated with the docking station to the monitoring device.

13. The computer program product of claim 9, further comprising
identifying audio data to be transmitted to the monitoring device; and
transmitting the audio data to the monitoring device.

14. A method comprising:
identifying, by one or more processors of a monitoring device, a user device;
determining, by the one or more processors of the monitoring device, a type of network connection established with the user device;
establishing, by the one or more processors of the monitoring device, a communications session with the user device; and
transmitting, by the one or more processors of the monitoring device, monitoring data.

15. The method of claim 14, further comprising:
receiving, by the one or more processors of the monitoring device, audio data from the user device; and
outputting, by the one or more processors of the monitoring device, at least a portion of the received audio data from the user device.

16. The method of claim 14, further comprising:
determining, by the one or more processors of the monitoring device, if the user device is connected locally, based upon, at least in part, a type of network connection with the user device;
in response to determining the user device is connected locally, establishing, by the one or more processors of the monitoring device, a local communications session; and
in response to determining the user device is not connected locally, establishing, by the one or more processors of the monitoring device, a remote communications session.

17. The method of claim 16, wherein
if the communications session is the local communications session, transmitting the monitoring data associated with the infant further comprises transmitting high resolution monitoring data associated with the infant; and
if the communications session is the remote communications session, transmitting the monitoring data associated with the infant further comprises transmitting low resolution monitoring data or audio only monitoring data associated with the infant.

18. The method of claim 14, further comprising determining that the user device is in standby mode;
determining that an alert has been identified;
transmitting a wake-up message to the user device; and
transmitting the monitoring data to the user device.

19. The method of claim 14, further comprising
identifying a change in the type of network connection established with the user device;
determining a current type of network connection available to connect with the user device; and
establishing a new communications session with the user device based upon, at least in part, the current type of network connection.

20. The method of claim 14, further comprising
identifying a docking station connected to the user device;
receiving one or more parameters of the docking station;
transmitting monitoring data based upon, at least in part, the received parameters of the docking station.
